(19) United States
(12) Patent Application Publication
(10) Pub. No.: US 2008/0278423 A1
(43) Pub. Date: Nov. 13, 2008

(54) Driving method to improve response time of twistred nematic and super twisted nematic LCDs without increasing GRAM

(75) Inventors: Shi-Ming Cheng, Tainan City (TW); Huai-Yi Hsu, Taipei County (TW); Chin-Wei Chien, Taipei City (TW)

Correspondence Address: Joe McKinney Muncy, PO Box 1364, Fairfax, VA, 22038-1364, US

(73) Assignee: Sitronix Technology Corp.

(21) Appl. No.: 11/797,860

(22) Filed: May 8, 2007

(51) Int. Cl. G09G 3/36

(52) U.S. Cl. 345/88

(57) ABSTRACT

A driving method to improve response time of twisted nematic (TN) and super twisted nematic (STN) passive matrix LCDs without increasing graphic memory (GRAM) adopts an over-driving operation principle to convert data of three primary colors to YCbCr data and over-driving YCbCr data. Then compressing, sampling and combining are performed through a video compression standard to further reduce a portion of storage bits of the YCbCr data and over-driving YCbCr data. Through an output frequency doubling circuit an over-driving compensation potential higher or lower than the original output potential is flexibly given N times according to the over-driving Y′Cb′Cr′ data within the update time period of each data bus. Thereby the response time of the LCDs improves without increasing the GRAM and dynamic picture blurring phenomenon also improves.

### FIELD OF THE INVENTION

The present invention relates to a driving technique for passive matrix LCDs and particularly to a over-driving method to shorten response time and improve blurring phenomenon of dynamic pictures of twisted nematic (TN) and super twisted nematic (STN) passive matrix LCDs without increasing graphic random access memory (GRAM).

### BACKGROUND OF THE INVENTION

LCDs can be divided into a passive matrix LCD (PM-LCD) and an active matrix LCD (AM-LCD) according to the display driving method. The driving method of PM-LCD has an upper glass panel and a lower glass panel. A transparent and horizontal ITO (Indium Tin Oxide) electrode is formed on the upper glass panel. The other panel has a transparent and vertical ITO electrode formed thereon. The two glass panels are coupled with liquid crystals filled in the middle. The electrodes of the upper and lower panels cross to form a grid portion which becomes the pixel displaying on the display panel. The potential difference of the pixel results from an external voltage controls the electrodes in two directions, thereby the liquid crystals in the driving pixels can be driven and twisted.

The common TN and STN are PM-LCD products. They do not have non-linear elements (somewhat like a switch element) to control operation of liquid crystals in the pixel. Hence each pixel is formed by an overlapping area of the wiring of a common electrode and the wiring of a vertical segment. The basic operation principle is based on the photoelectric effect generated by the Root Mean Square Value (RMS) of the voltage applied to the liquid crystal material. The response time of the liquid crystals has to be much greater than the scanning period of the driving pulse. If the frame rate is 60 Hz, the interval of pick up time of each horizontal scanning line (namely common electrode) is 16.67 ms. The response time required by the liquid crystal material is generally 200 ms. This is the necessary condition of the liquid crystals responsive to RMS.

However, adopted the conventional Alt & Pleshko Theory (APT) to display dynamic pictures, the response time of material of liquid crystals is too slow. A picture blurring phenomenon occurs. On the other hand, using fast response liquid crystals will result in serious flicker phenomenon on the picture. The contrast of the picture also decreases significantly.

Refer to FIG. 1 for the process block diagram of a conventional over-driving circuit using a LUT (look up table). The general approach is to provide a different driving voltage V′ according to different pictures. In practice, a picture determination circuit 10 is used to compare a current field with a previous field stored in a GRAM 11 in (or outside) a driving device through a comparison circuit 12. If the data are different, the picture is treated as a dynamic picture. A LUT circuit 13 is used to process the data of the dynamic picture and output a corresponding over-driving voltage. This is the operation principle of the conventional over-driving circuit.

LUT is an index array for a new over-driving voltage V′ value table containing constants derived by integrating and synthesizing some non-linear and complex processes to save the complicated calculation during the entire process. It can improve actual image processing efficiency. The sent out voltage can get a corresponding correct over-driving voltage V′ output by the segment electrode. Thus the APT response time used in the conventional passive matrix LCD (TN and STN types) can be shortened to reduce the image blurring phenomenon during displaying dynamic pictures.

The passive matrix LCD adopts a passive structure. There is no switch element in each pixel. Hence electric charges cannot be locked after the storage capacitor of the liquid crystal is charged. After the segment electrode has output voltage, the electric charges in the liquid crystal capacitor tend to leak through a stray capacitor or other charging circuits. As a result, the voltage of liquid crystal capacitor cannot maintain a constant level. After the segment electrode is charged in a frame time period, the actual effective potential of the capacitor of the liquid crystal pixel is much smaller than the output of the segment electrode. This will result in a blurring phenomenon at the edge of the dynamic picture.

Moreover, the over-driving compensation method, aside from storing the data of previous field to compare with the data of the current field, also has to store data of the entire compensation field after comparison. Hence an extra GRAM has to be added to store the data of the entire compensation field after comparison. This is beyond the original memory capacity in the original driving IC. The memory capacity often has to be doubled to accommodate this requirement. The increased memory demand results in a higher manufacturing cost. The die size required in producing the driving IC also is larger.

### SUMMARY OF THE INVENTION

The primary object of the present invention is to solve the aforesaid disadvantages by providing a driving method for APT of twisted nematic (TN) and super twisted nematic (STN) passive matrix LCDs that employs conversion of color space data and includes a driving compensation approach and a high frequency update method, and bit allocation of stored data to get a sum by adding the original data of odd number and following even number with the over-driving data, with the sum same as stored bits of the three primary colors (RGB) of the odd and even number of each original set. Thereby the response time of TN and STN passive matrix LCDs can be shortened and the blurring phenomenon of dynamic pictures can be improved without increasing the GRAM.

To achieve the foregoing object, the driving method of the invention employs the over-driving operation principle that has a dynamic picture determination mechanism to process the current data of the three primary colors (RGB). When the current data are different from the data of a previous field, by a LUT process circuit to search the table, a corresponding data of three primary colors output after over-driving is sent out. To save the storage space of GRAM, the data of the three primary colors (RGB) of the current image are converted to YCbCr data. The over-driving data of the three primary colors (RGB) output from the current image also are converted to over-driving Y′Cb′Cr′ data. Then the YCbCr data and the over driving Y′Cb′Cr′ data are compressed, sampled and combined through a video information compression standard to further reduce the storage bits of CbCr of the YCbCr data. The storage bits of Y′Cb′Cr′ data of the over-driving Y′Cb′Cr′ also decrease. Through bit allocation the reduced YCbCr datas and the over-driving Y′Cb′Cr′ datas are stored together in the GRAM. Through an output frequency doubling circuit, and in the update time period of each data bus, N times of over-driving compensation potential higher (or lower) than the original output potential is flexibly given according to the over-driving Y′Cb′Cr′ datas. N is an integer greater than 2 and smaller than 8

The data of the three primary colors (RGB) output from over-driving are processed through a LUT to send different over-driving compensation potentials corresponding to different pictures. The over-driving compensation potential has a range greater than or equal to 0, but is smaller than the maximum potential which drives the liquid crystals. Compression and sampling for conversion of the data of the three primary colors (RGB) to YCbCr are performed according one of following sampling and processing rules: Y:Cb:Cr=4:2:2, Y:Cb:Cr=4:2:0 and Y:Cb:Cr=4:1:1.

In general, the data voltage output once in one frame time period also charges the liquid crystal capacitor. As each pixel of the passive matrix LCD (TN and STN types) does not have a switch element, electric charges in the liquid crystal capacitor tend to leak out through stray capacitors or the charging circuit thereof. Hence after elapse of one frame time period the voltage in the liquid crystal capacitor does not reach the expected target voltage of input data bus. The invention provides repetitive output of N times within one frame time period (namely charge the pixel capacitor N times within one frame time period) to provide a higher (or lower) over-driving compensation voltage. Hence the liquid crystals can be twisted in a shorter time to get a desired target luminance. As a result, the moving image blurring problem caused by a slow response time on the TN and STN passive matrix LCDs that occurs to the conventional techniques can be greatly improved through of the invention.

By means of the over-driving method a target luminance can be achieved within a frame time period after multiple times of driving. Hence a relative less accurate voltage driving with few bits can also improve the response time. In the condition of without adding extra GRAM, the data of a previous field and a current field can be stored together in a GRAM of an original driving IC through the over-driving compensation process to improve the response time of the TN/STN passive matrix LCDs.

The foregoing, as well as additional objects, features and advantages of the invention will be more readily apparent from the following detailed description, which proceeds with reference to the accompanying drawings. The embodiments depicted below serve only for illustrative purpose, and are not the limitation of the invention.

### BRIEF DESCRIPTION OF THE DRAWINGS

FIG. 1 is a process block diagram of a conventional over-driving circuit.

FIG. 2 is a schematic view of waveforms output by a segment electrode within a scanning frame time period.

FIG. 3 is a schematic view of level waveforms output by a segment signal in one line time period dividing into 16 equal portions.

FIG. 4 is a schematic view of the positions of liquid crystals in one pixel from the initial luminance to a target luminance.

FIG. 5 is a block diagram of an over-driving circuit of the invention.

FIG. 6 is a schematic chart showing comparison of the frequency written in a panel through a segment electrode of a driving element that is N times (6 times) of the update frequency of input data bus and the original update frequency.

FIG. 7 is a schematic chart showing comparison of the frequency written in a panel with an over-driving voltage through a segment electrode of a driving element, with the frequency being N times (6 times) of the update frequency of input data bus and the original update frequency of the original voltage.

FIG. 8 is a schematic view of output level waveforms in one line time period divided into 16 equal portions based on an over-driving compensated segment signal (SEG).

FIG. 9 is a schematic view of the data of three primary colors (RGB) converted according to YCbCr (4:2:2) and resulted in less storing bits.

### DETAILED DESCRIPTION OF THE PREFERRED EMBODIMENT

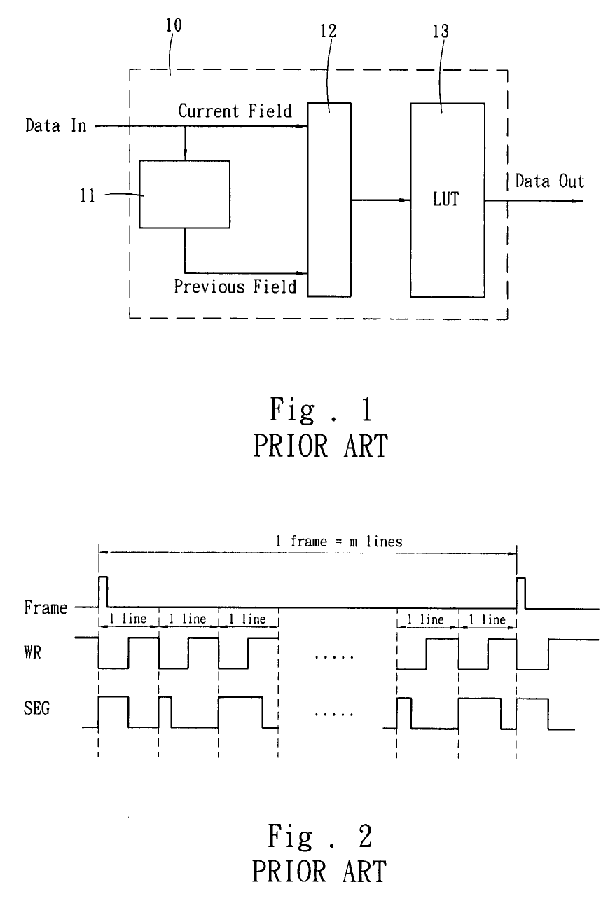

The driving method for TN/STN passive matrix LCDs according to the invention has a driving IC segment which, based on different data of the digital three primary colors (RGB) input to each frame, converts and outputs different gray scale voltages. As TN and STN have only black and white conditions, generation of the gray scale is differentiated by pulse width modulation (PWM) within the time period of scanning one line. Referring to FIG. 2 for the schematic view of output waveforms within a scanning frame time period based on a segment signal. Presuming there are m scanning lines (for m×n matrix LCD) within a frame time period, one read write (WR) period indicates one line time of scanning. Referring 2, the segment electrode signal can output different PWM waveforms according to different output gray scale voltages of the data.

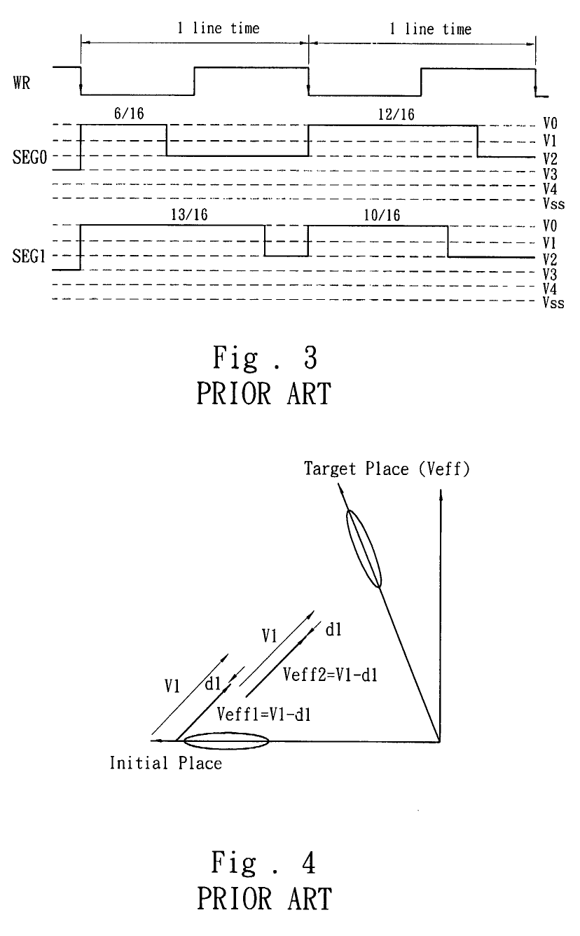

Referring to FIG. 3, assuming the charging time of one scanning line is divided into 16 equal portions, the full black portion of a segment electrode signal SEG0 in the one line time period occupies 6/16. The next line occupies 12/16, and the full black portion of a segment electrode signal SEG1 in the one line time period occupies 13/16. The next line occupies 10/16. However, as there is no switch element in each pixel of the passive matrix LCDs, after the segment electrode has output voltage, electric charges of the capacitor in the liquid crystals leak out through spray capacitors or a charging circuit. As a result, the capacitor of liquid crystals cannot be maintained at a constant voltage level. Therefore after the segment electrode is charged in one frame time period, the actual effective potential of the capacitor of the liquid crystal pixel is much smaller than the segment electrode output.

Refer to FIG. 4 for a schematic view of the positions of the liquid crystals in one pixel from the initial luminance to a target luminance. The segment electrode has to be charged through a plurality of frame time periods to reach an effective voltage Veff for the liquid crystals in the pixels to reach a target position from an initial position. This is why the response time of TN/STN passive matrix LCDs becomes so slow. When the segment electrode of one frame provides a charge voltage V1 for a liquid crystal capacitor, due to leakage voltage d1 of the spray capacitors or charge circuit, the final effective voltage of the segment electrode in the time of the first frame against the liquid crystal capacitor is V1−D1=Veff1. Similarly, the effective voltage of the segment electrode in the time of the second frame against the liquid crystal capacitor is V1−D1=Veff2. Assumed the segment electrode has to sent out the same voltage for twelve times to reach the target luminance, the response time of the LCD is the time of each frame of 16.67 ms×12, which is about 200 ms.

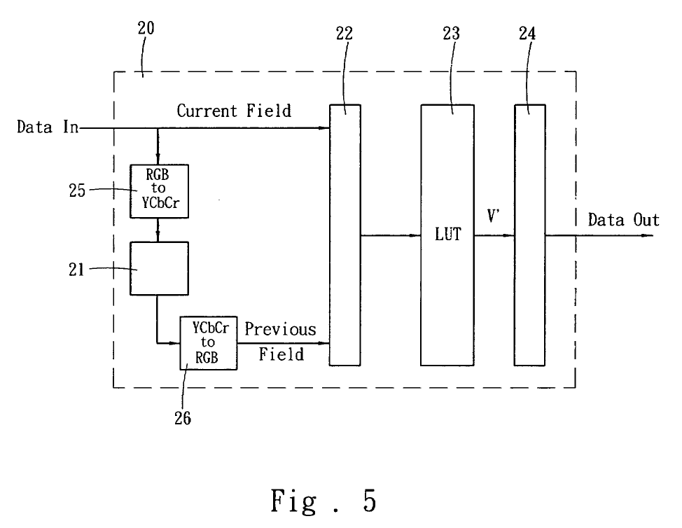

Refer to FIG. 5 for the block diagram of an over-driving circuit of the invention. Through a general driving operation principle, the invention provides different over-driving voltage values V′ according to different pictures. Through a picture determination circuit 20 and a comparison means 22 data of a newly current field is compared with the data of a previous field stored in advance in a GRAM 21 inside (or outside) of a driving device. A different comparison result indicates a dynamic picture. In general, the dynamic picture data is obtained by searching a table through a LUT process circuit 23, then a corresponding over-driving voltage V′ is sent out.

The comparison means 22 of the invention is located behind a data bus of the three primary color (RGB) to determine the dynamic picture. If the data of current picture are found different from the data of previous picture, through an output frequency doubling circuit 24 behind the LUT circuit 23, an over-driving compensation potential V′ higher (or lower) than the original output potential V is flexibly given N times within the update time period of each data bus. N is an integer greater or equal to 2, but less than 8 (2≦N≦8). The compensation potential V′ is a corresponding value based on the original output potential V and processed through the LUT. A corresponding over-driving output voltage is sent out. The voltage range is 0≦V′≦maximum driving voltage of the liquid crystals. Hence the frequency written in the display panel of the segment electrode of the driving element is N times of the update frequency of the data bus of the input three primary colors (RGB).

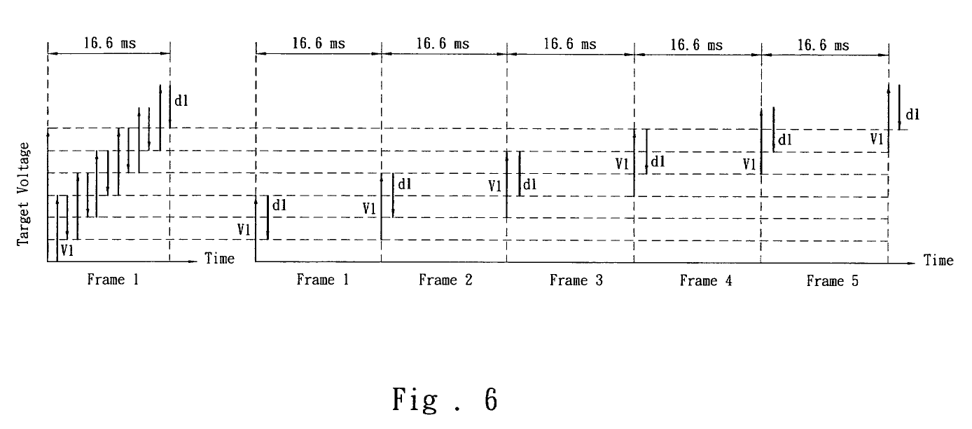

Refer to FIG. 6 for a schematic chart which shows comparison of the frequency written in a panel through a segment electrode of a driving element that is N times (6 times) of the update frequency of input data bus and the original update frequency. The right side indicates the target voltage for the liquid crystals in a pixel from the initial luminance to reach a targeted luminance. The segment electrode has to go through the time period of six frames to deliver the same output voltage V1 to reach the target luminance. Hence the response time is 16.6 ms×6, approximate 100 ms. Wherein d1 is the drop of the target voltage caused by electric leakage of the circuit. On the left side of FIG. 6, the segment electrode, within one data update period (namely one frame time) of the original output potential V1, repeatedly delivers the output voltage V1 six times through an output frequency doubling circuit 24. Hence within one frame time period the liquid crystals can be twisted to reach the target luminance. Therefore the response time can be shortened to one frame time of 16.6 ms.

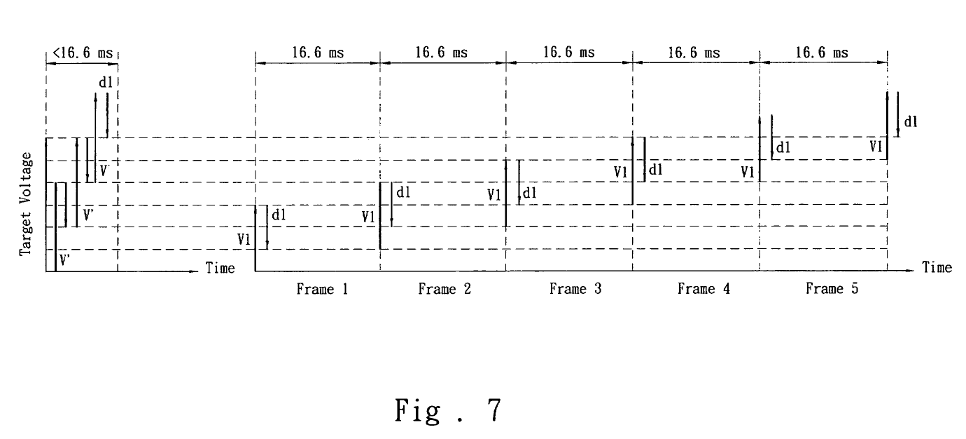

Refer to FIG. 7 for a schematic chart showing comparison of the frequency written in a panel through a segment electrode with an over-driving voltage of a driving element, with the frequency being N times (6 times) of the update frequency of input data bus and the original update frequency with the original voltage. On the left side of the drawing, the output voltage V1 of the segment electrode is substituted by an over-driving voltage V′. The response time can be shortened further (less than one frame time). Hence it can further improve the response time of TN/STN passive matrix LCDs. Such an approach not only allows the segment electrode to output an effective voltage greater (or smaller) than the original output potential V, it also can output repeatedly many times within one data update period. As a result, the liquid crystals can be twisted at a shorter time period to greatly improve the image blurring problem caused by slow response time of the TN/STN passive matrix LCDs.

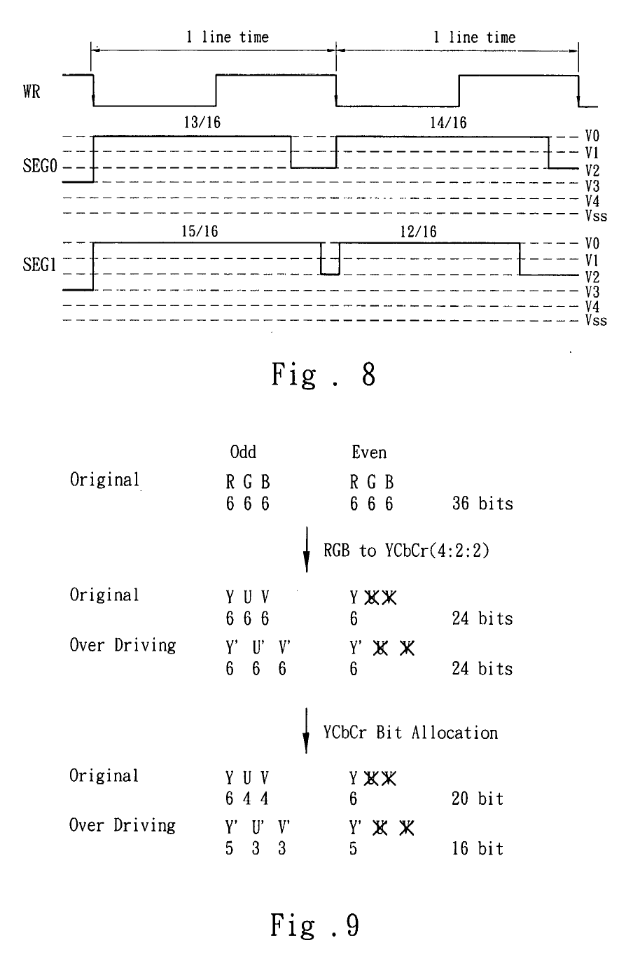

Refer to FIG. 8 for a schematic view of level waveforms of an over-driving compensation segment signal (over-driving of the output level waveforms shown in FIG. 3). The full black portion of the segment electrode SEG0 in one selected line time after over-driving is 13/16 of the entire one line time of scanning. The next line is 14/16. The full black portion of the segment electrode SEG1 in one selected line time is 15/16 of the entire one line time of scanning. The next line is 12/16.

By means of the invention, within each data update period, the segment electrode can output N times of over-driving compensation to make the liquid crystals in the pixel to reach or close to the effective voltage Veff from the initial position to a target position in a shorter time period (close to one frame time) to achieve the target luminance. Thus the blurring phenomenon of moving picture can be greatly improved. Moreover, as the basic driving method of TN/STN is APT, the operation principle is accomplished through photoelectric effect generated by applying a voltage RMS on the liquid crystals. Hence the over-driving voltage compensation method of the invention, after having gone through the RMS, does not produce serious flicker.

In addition, on storing the graphic data, the driving compensation method of the prior art has to add an extra GRAM to store a previous picture to compare with the data of the entire later compensation pictures to be compared with the current picture data. In this invention, the data of three primary colors (RGB) of the image may be converted to YCbCr data, and be compressed, sampled and combined according to a video compression standard (referring to FIG. 5). The data of the previous field is converted by a first conversion unit 25 which receives the image data of the three primary colors (RGB), and converts them to the YCbCr data. For dynamic images, the YCbCr data also is converted to over-driving YCbCr data. Then the YCbCr data and the over-driving YCbCr data are compressed, sampled and combined according to the video compression standard. The YCbCr data are stored in the GRAM 21 inside (or outside) the driving device. A second conversion unit 26 is provided to convert the YCbCr data to data of the three primary colors (RGB). Then the data are sent to the comparison means 22. The compression and sampling are performed according to one of the process rules as follow: Y:Cb:Cr=4:2:2, Y:Cb:Cr=4:2:0 and Y:Cb:Cr=4:1:1. As Y represents the luminance signal, and Cb and Cr represent color differential signals, the Y portion which is most sensitive to human vision is sampled and compressed according to a sampling proportion, then is stored in the GRAM to reduce the size of required memory of the driving device.

Refer to FIG. 9 for a schematic view of the data of three primary colors converted according to YCbCr (4:2:2) and resulted in less bits. Assumed the RGB data is in a 6 bits format, before conversion of color spectrum, the sum of data of the three primary colors of each set of 18 bits odd and even numbers is 36 bits. The two RGB of the odd and even numbers have color spectrum conversion according to YCbCr 4:2:2 to reduce the storage data volume. Hence after conversion, the data of the previous picture is 24 bits. The data of the entire picture of over-driving compensation also is 24 bits. Both data are added to become 48 bits. It is 12 bits more than the original 36 bits. Hence the memory has to increase by ⅓. Through conversion of color space such as Y:Cb:Cr=4:2:2, and a bit allocation process for Cb and Cr of the original YCbCr data of the odd and even numbers after conversion, the original storage 6 bits can be changed to 5 bits. Thus the original YCbCr data finally occupies total 20 bits of the memory. The data Y′ of the over-driving data Y′Cb′Cr′ of the odd and even numbers after conversion occupies only 5 bits of the storage, while Cb′ and Cr′ occupy only 3 bits of the storage. Thus the over-driving Y′Cb′Cr′ data totally occupy 16 bits. After bit allocation of the data in the color space through data conversion and storing, the sum of the original data of the odd and adjacent even number and the over-driving data is 36 bits. It is same as the data volume of each set of odd and even numbers of RGB data before color space conversion. Hence the invention can improve the response time of TN and STN passive matrix LCDs without adding extra GRAM, and also improve the blurring phenomenon of the dynamic pictures.

As the response time of the passive matrix LCDs is too slow, this is why the storage bits can be reduced as previously discussed. By adopting the over-driving method set forth above, in a frame time period multiple times of driving is needed to reach the target luminance. By reducing a few bits with a less accurate voltage to do driving can improve the response time without increasing extra GRAM. The data of the previous picture and the current picture can go through the over-driving compensation process and be stored together in one GRAM inside the original driving IC. And the response time of the TN/STN passive matrix LCDs can be improved as desired.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A driving method to improve response time of twisted nematic (TN) and super twisted nematic (STN) passive matrix LCDs without increasing graphic memory, comprising:
processing data of three primary colors according to an over-driving operation principle through a dynamic picture determination mechanism and outputting over-driving data of the three primary colors when current data is different from data of a previous picture; converting the data of the three primary colors of the current picture to YCbCr data, and converting the over-driving data of the three primary colors to over-driving Y′Cb′Cr′ data;
compressing, sampling and combining the YCbCr data and the over-driving Y′Cb′Cr′ data of the current picture according to a video compression standard; performing bit allocations of reduced CbCr storing bits of the YCbCr data of the current picture and reduced Y′Cb′Cr′ data of the over-driving Y′Cb′Cr′ and storing the reduced YCbCr data and the reduced over-driving Y′Cb′Cr′ data in a graphic random access memory (GRAM); and providing N times of over-driving compensation potential higher or lower than an original output potential according to the over-driving data within a update time period of each data bus through an output frequency doubling circuit.

2. The driving method of claim 1, wherein the over-driving data of the three primary colors send out different over-driving compensation potential corresponding to different pictures through a look up table (LUT) circuit, the over-driving compensation potential being greater than 0 and smaller than a maximum voltage driving liquid crystals.

3. The driving method of claim 1, wherein the compression and sampling is accomplished by employing one of the following sampling rules: Y:Cb:Cr=4:2:2, Y:Cb:Cr=4:2:0 and Y:Cb:Cr=4:1:1.

4. The driving method of claim 1, wherein the N is an integer greater than or equal to 2 and smaller than 8.
